(19) United States
(12) Patent Application Publication
(10) Pub. No.: US 2025/0279567 A1
(43) Pub. Date: Sep. 4, 2025

(54) RESONANT FILTER

(71) Applicant: Suzhou Luxshare Technology Co., Ltd., Suzhou City (CN)

(72) Inventors: ShaoDong LI, Suzhou City (CN); GuiPing GAO, Suzhou City (CN)

(73) Assignee: Suzhou Luxshare Technology Co., Ltd., Suzhou City (CN)

(21) Appl. No.: 19/032,970

(22) Filed: Jan. 21, 2025

(30) Foreign Application Priority Data
Mar. 4, 2024 (CN) 202410242503.3

(51) Int. Cl. H01P 7/06

(52) U.S. Cl. CPC H01P 7/06

(57) ABSTRACT

A resonant filter includes a casing, metal resonant sheets, an input port and an output port. The casing has an accommodating cavity and a first inner surface and a second inner surface arranged opposite to each other, and is provided with a first through hole and a second through hole communicating with the accommodating cavity. The metal resonant sheets are located in the accommodating cavity and are disposed on the first inner surface and the second inner surface. The metal resonant sheets are substantially located in a same plane and are distributed oppositely. Coupling occurs between the metal resonant sheets to form a signal connection. The input port is engaged with the first through hole and is connected to one metal resonant sheet. The output port is engaged with the second through hole and is connected to another metal resonant sheet.

### CROSS REFERENCE TO RELATED PRESENT DISCLOSURE

This application claims the priority benefit of Chinese Patent Application Serial Number 202410242503.3, filed on Mar. 4, 2024, the full disclosure of which is incorporated herein by reference.

### TECHNICAL FIELD

The present disclosure relates to the technical field of filters, in particular to a resonant filter.

### RELATED ART

A filter is a frequency selective component used to filter out signals in useless frequency bands (i.e., attenuate signals outside the passband) and retain signals in useful frequency bands (i.e., allow signals within the passband to pass).

The existing resonant filter mainly comprises a housing provided with a cavity and an opening, a cover plate covering the opening, and a resonant member disposed in the cavity. The resonant member is generally of multi-row design and comprises a bending member, a plurality of metal resonant sheets, or a combination thereof. The resonant member of multi-row design occupies a large space in the cavity, which is not conducive to the miniaturization design of the resonant filter. There are problems of high processing difficulty and low dimensional accuracy in the resonant member including the bending member.

Therefore, it is urgent to provide a resonant filter to solve the above problems.

### SUMMARY

The present disclosure provides a resonant filter, which includes a casing, a plurality of metal resonant sheets, an input port and an output port, wherein the casing has an accommodating cavity and a first inner surface and a second inner surface arranged opposite to each other, and is provided with a first through hole and a second through hole communicating with the accommodating cavity; the plurality of metal resonant sheets are located in the accommodating cavity and disposed on the first inner surface and the second inner surface, the plurality of metal resonant sheets are substantially located in the same plane and are distributed oppositely, and coupling occurs between the plurality of metal resonant sheets to form a signal connection; the input port is engaged with the first through hole and connected to one of the plurality of metal resonant sheets; the output port is engaged with the second through hole and connected to another of the plurality of metal resonant sheets.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a three-dimensional diagram of a resonant filter according to an embodiment of the present disclosure;

FIG. 2 is an exploded schematic diagram of an embodiment of the resonant filter of FIG. 1;

FIG. 3 is a cross-sectional schematic diagram of the resonant filter of FIG. 2;

FIG. 4 is a three-dimensional diagram of a resonant filter according to another embodiment of the present disclosure;

FIG. 5 is an exploded schematic diagram of an embodiment of the resonant filter of FIG. 4;

FIG. 6 is a cross-sectional schematic diagram of the resonant filter of FIG. 5;

FIG. 7 is an exploded schematic diagram of another embodiment of the resonant filter of FIG. 1;

FIG. 8 is a cross-sectional schematic diagram of the resonant filter of FIG. 7;

FIG. 9 is a diagram illustrating passband insertion loss curves of the resonant filter of FIG. 3 and the resonant filter of FIG. 8;

FIG. 10 is a three-dimensional diagram of a resonant filter according to still another embodiment of the present disclosure;

FIG. 11 is an exploded schematic diagram of an embodiment of the resonant filter of FIG. 10;

FIG. 12 is a cross-sectional schematic diagram of the resonant filter of FIG. 11;

FIG. 13 is an exploded schematic diagram of another embodiment of the resonant filter of FIG. 10; and

FIG. 14 is a cross-sectional schematic diagram of the resonant filter of FIG. 13.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

In addition, although the terms such as “first”, “second”, and the like may be used herein to describe different elements, the terms are used only to distinguish the elements or operations described in the same technical terms.

The embodiments of the present disclosure provide a resonant filter. In some embodiments, the problem that it is not conducive to the miniaturization design of the existing resonant filter due to the resonant member of multi-row design can be solved. In some embodiments, the problems of high processing difficulty and low dimensional accuracy due to the bending member of the resonant member of the existing resonant filter can be solved.

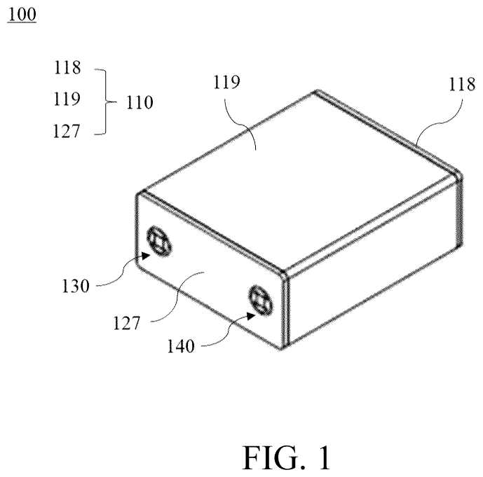

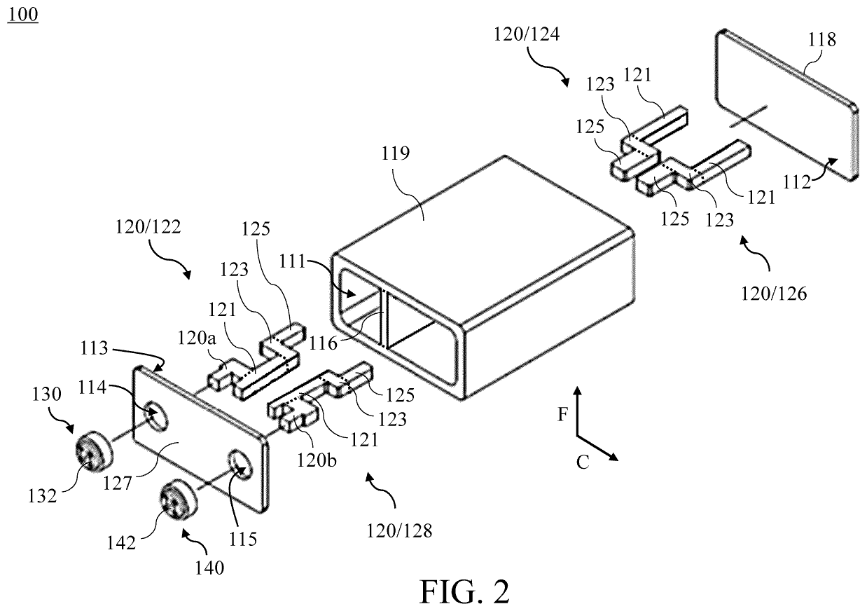

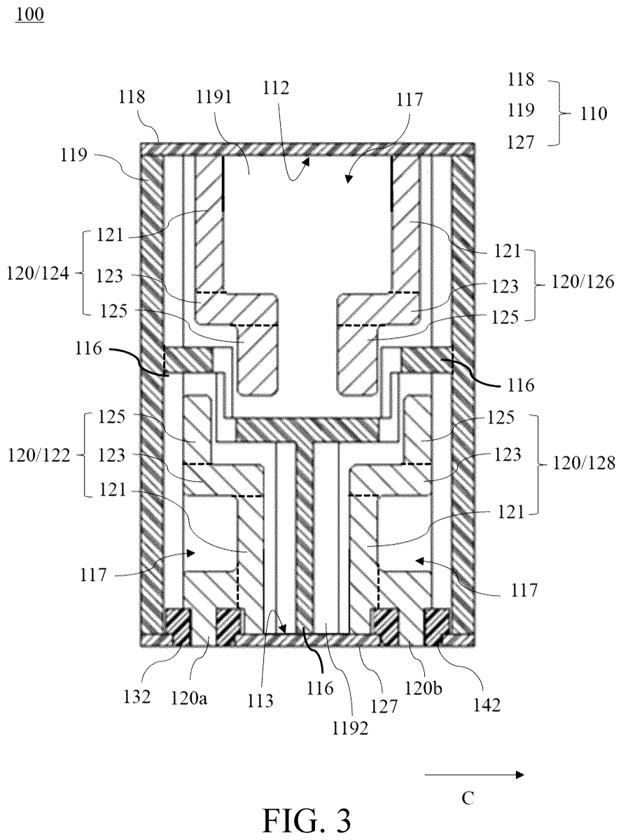

Please refer to FIG. 1 to FIG. 3, FIG. 1 is a three-dimensional diagram of a resonant filter according to an embodiment of the present disclosure, FIG. 2 is an exploded schematic diagram of an embodiment of the resonant filter of FIG. 1, and FIG. 3 is a cross-sectional schematic diagram of the resonant filter of FIG. 2. As shown in FIG. 1 to FIG. 3, a resonant filter 100 is suitable for frequency bands above 5.5 GHz (Gigahertz), and comprises a casing 110, a plurality of metal resonant sheets 120, an input port 130, and an output port 140. The casing 110 has an accommodating cavity 111 and a first inner surface 112 and a second inner surface 113 arranged opposite to each other, and is provided with a first through hole 114 and a second through hole 115 communicating with the accommodating cavity 111. The plurality of metal resonant sheets 120 are located in the accommodating cavity 111 and disposed on the first inner surface 112 and the second inner surface 113 (that is., the plurality of metal resonant sheets 120 are distributed in two rows), the plurality of metal resonant sheets 120 are substantially located in the same plane and are distributed oppositely, and coupling occurs between the plurality of metal resonant sheets 120 to form a signal connection. The input port 130 is engaged with the first through hole 114 and is connected to one of the plurality of metal resonant sheets 120. The output port 140 is engaged with the second through hole 115 and is connected to another metal resonant sheet 120 of the plurality of metal resonant sheets 120.

Each of the plurality of metal resonant sheets 120 may be, but is not limited to, a sheet material with a metal surface or a metal sheet. Therefore, the plurality of metal resonant sheets 120 do not need to be bent, and have the advantage of simple processing. Since the plurality of metal resonant sheets 120 are substantially located in the same plane and are distributed oppositely, the flat design of the resonant filter 100 is realized (that is, the length of the resonant filter 100 along the first direction F is reduced, and the first direction F is perpendicular to a second direction; in the embodiment, the first direction F is the thickness direction of the resonant filter 100, and the second direction is the arrangement direction C of the plurality of metal resonant sheets 120), which is conducive to the miniaturization of the resonant filter 100. In addition, the coupling occurs between the two adjacent metal resonant sheets 120 forms the signal connection, and the design of bending member is not required, so there is no problem of high processing difficulty and low dimensional accuracy. Besides, the thickness of the metal resonant sheet 120 may be, but not limited to, 0.5 millimeters (mm) to 3 mm; the thicknesses of the plurality of metal resonant sheets 120 are usually the same, if not, the difference in thickness may be, but not limited to, less than 50%; the thickness of the metal resonant sheet 120 is related to the size and target requirements of the resonant filter 100. Furthermore, the shape of the metal resonant sheet 120 may be designed according to its frequency and the coupling requirements with the adjacent metal resonant sheets 120, while ensuring that the size of the metal resonant sheet 120 is as small as possible. Furthermore, the plurality of metal resonant sheets 120 may be fixed on the first inner surface 112 or the second inner surface 113 by laser welding, solder paste welding or brazing.

In one embodiment, the material of the plurality of metal resonant sheets 120 may be, but not limited to, iron or iron alloy, and the processing method of the metal resonant sheets 120 may be, but not limited to, laser cutting, wire cutting, or sheet metal stamping.

In one embodiment, the plurality of metal resonant sheets 120 may be arranged alternately on the first inner surface 112 and the second inner surface 113.

In one embodiment, each of the plurality of metal resonant sheets 120 may comprise an upright section 121, an extension section 123 extending from one end of the upright section 121, and a coupling section 125 extending from one end of the extension section 123 away from the upright section 121. One end of the upright section 121 away from the extension section 123 is fixed on the first inner surface 112 or the second inner surface 113. The coupling section 125 of each of the plurality of metal resonant sheets 120 is close to the coupling section 125 of the adjacent metal resonant sheet 120. The two adjacent metal resonant sheets 120 may be two metal resonant sheets 120 arranged opposite to each other, or two metal resonant sheets 120 arranged along the arrangement direction C.

In one embodiment, the plurality of metal resonant sheets 120 are not physically connected to each other. In one example, the plurality of metal resonant sheets 120 fixed on the first inner surface 112 are arranged at intervals, and the plurality of metal resonant sheets 120 fixed on the second inner surface 113 are arranged at intervals; the distance between two adjacent metal resonant sheets 120 fixed on the first inner surface 112 and the second inner surface 113 is related to the size and target requirements of the resonant filter 100.

In one embodiment, the casing 110 is further provided with a plurality of partition ribs 116, and the plurality of partition ribs 116 divide the accommodating cavity 111 into a plurality of resonant cavities 117 arranged in two rows, the plurality of metal resonant sheets 120 are disposed in the plurality of resonant cavities 117, and the two adjacent resonant cavities 117 communicate with each other. Specifically, the adjacent upper and lower rows of resonant cavities 117 communicate with each other, and the plurality of metal resonant sheets 120 are disposed in the plurality of resonant cavities 117, so that coupling occurs between the two metal resonant sheets 120 arranged oppositely to form the signal connection. One resonant cavity 117 may be provided with one or more metal resonant sheets 120, and the number of resonant cavities 117, the number of metal resonant sheets 120 and the corresponding arrangement relationship between the resonant cavities 117 and the metal resonant plates 120 can be designed according to actual needs.

In one embodiment, the casing 110 may comprise a bottom plate 118, a housing 119 and a cover plate 127, the housing 119 is provided with a first opening 1191 and a second opening 1192 arranged opposite to each other, the bottom plate 118 is disposed at the first opening 1191, and the cover plate 127 is disposed at the second opening 1192. The bottom plate 118, the housing 119 and the cover plate 127 are surrounded to form the accommodating cavity 111, the bottom plate 118 has the first inner surface 112, and the cover plate 127 has the second inner surface 113. The material of the bottom plate 118, the housing 119 and the cover plate 127 may be, but not limited to, aluminum or aluminum alloy, and the processing method of the housing 119 may be, but not limited to, computer numerical control (CNC) process, die casting, or extrusion molding.

In one embodiment, the first through hole 114 and the second through hole 115 are arranged on the bottom plate 118 or the cover plate 127. The input port 130 comprises a first support seat 132, the metal resonant sheet 120 connected to the input port 130 passes through the first support seat 132 through a first tap plate 120a and then extends out of the casing 110, and the first tap plate 120a and the metal resonance sheet 120 connected to the input port 130 are integrally formed. The output port 140 comprises a second support seat 142, the metal resonant sheet 120 connected to the output port 140 passes through the second support seat 142 through a second tap plate 120b and then extends out of the casing 110, and the second tap plate 120b and the metal resonant sheet 120 connected to the output port 140 are integrally formed. The material of the first support seat 132 and the second support seat 142 may be, but not limited to, engineering plastics, such as polytetrafluoroethylene (PTFE), perfluoroalkoxy alkane (PFA), and polyphenylene sulfide (PPS); the processing method of the first support seat 132 and the second support seat 142 may be, but not limited to, CNC process, injection molding process, or powder sintering process. The first support seat 132 and the second support seat 142 may be engaged with the first through hole 114 and the second through hole 115 by an adhesive. The first tap plate 120a is configured to feed the signal into the resonant filter 100. The second tap plate 120b is configured to feed the signal out of the resonant filter 100. The number of the first tap plates 120a and the number of the second tap plates 120b are related to the number of channels of the resonant filter 100. In this embodiment, the resonant filter 100 is a single-channel filter, so the number of the first tap plates 120a and the number of the second tap plates 120b are both one.

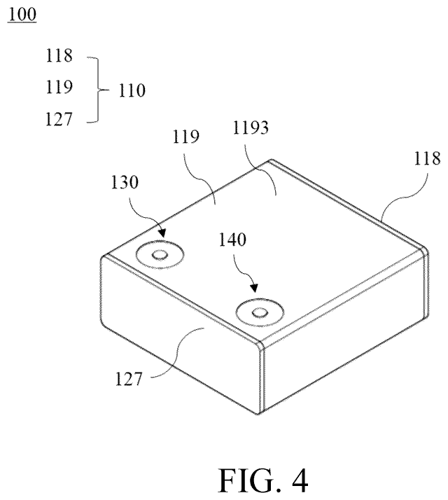

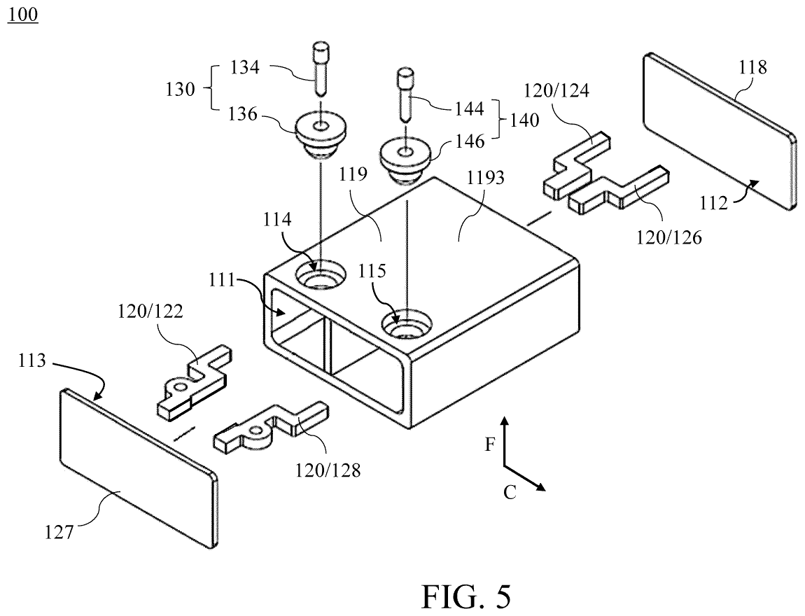

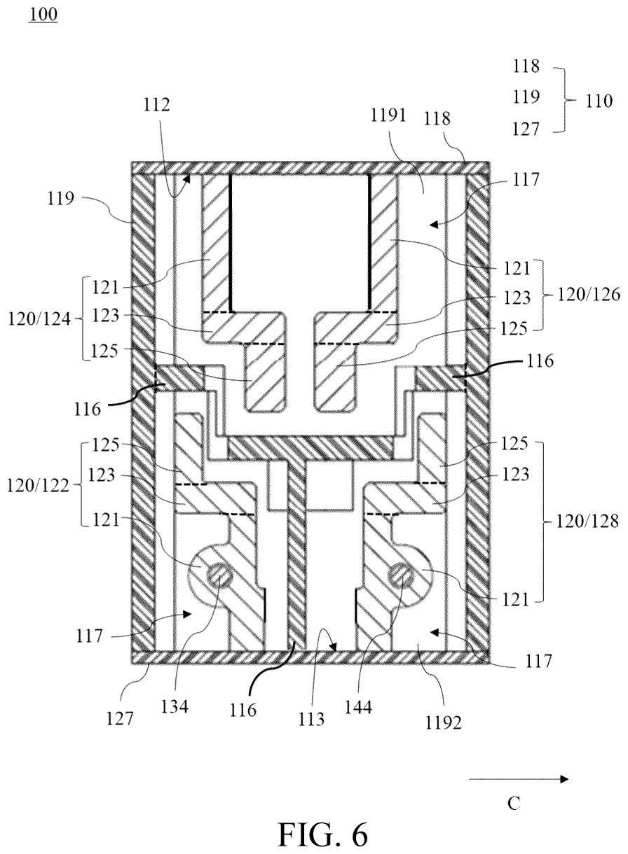

Please refer to FIG. 4 to FIG. 6, FIG. 4 is a three-dimensional diagram of a resonant filter according to another embodiment of the present disclosure, FIG. 5 is an exploded schematic diagram of an embodiment of the resonant filter of FIG. 4, and FIG. 6 is a cross-sectional schematic diagram of the resonant filter of FIG. 5. As shown in FIG. 4 to FIG. 6, it can be seen that the difference between the embodiment of FIG. 4 to FIG. 6 and the embodiment of FIG. 1 to FIG. 3 lies in the arrangement positions of the first through hole 114 and the second through hole 115 and the design of the input port 130 and the output port 140. In FIG. 4 to FIG. 6, the first through hole 114 and the second through hole 115 may be arranged on the same side wall of the housing 119, and the same side wall may be a side wall 1193 of the housing 119 parallel to the arrangement direction C of the metal resonant sheets 120. The input port 130 may comprise a first port conductor 134 and a first base 136, one end of the first port conductor 134 is connected to one metal resonant sheet 120, the first base 136 is engaged with the first through hole 114, and the other end of the first port conductor 134 passes through the first base 136 and then extends out of the casing 110. The output port 140 may comprise a second port conductor 144 and a second base 146, one end of the second port conductor 144 is connected to another metal resonant sheet 120, the second base 146 is engaged with the second through hole 115, and the other end of the second port conductor 144 passes through the second base 146 and then extends out of the casing 110. The material of the first base 136 and the second base 146 may be, but not limited to, engineering plastics. The processing method of the first base 136 and the second base 146 may be, but not limited to, CNC process, injection molding process, or powder sintering process. The first base 136 and the second base 146 may be engaged with the first through hole 114 and the second through hole 115 by an adhesive. The first port conductor 134 is configured to feed the signal into the resonant filter 100. The second port conductor 144 is configured to feed the signal out of the resonant filter 100. The number of the input port 130 and the number of the output port 140 are related to the number of channels of the resonant filter 100. In this embodiment, the resonant filter 100 is a single-channel filter, so the number of the input ports 130 and the number of the output ports 140 are both one.

In one embodiment, the first through hole 114 and the second through hole 115 may be arranged on different side walls of the housing 119, and the different side walls may be two corresponding side walls of the housing 119 parallel to the arrangement direction C of the metal resonant sheets 120. The input port 130 may comprise a first port conductor 134 and a first base 136, one end of the first port conductor 134 is connected to one metal resonant sheet 120, the first base 136 is engaged with the first through hole 114, and the other end of the first port conductor 134 passes through the first base 136 and then extends out of the casing 110. The output port 140 may comprise a second port conductor 144 and a second base 146, one end of the second port conductor 144 is connected to another metal resonant sheet 120, the second base 146 is engaged with the second through hole 115, and the other end of the second port conductor 144 passes through the second base 146 and then extends out of the casing 110. In other words, the input port 130 and the output port 140 can be arranged in a more flexible manner to meet different design requirements.

Please refer to FIG. 1 to FIG. 3. The plurality of metal resonant sheets 120 comprise a first resonant sheet 122, a second resonant sheet 124, a third resonant sheet 126 and a fourth resonant sheet 128 which are sequentially connected in signal connection. The first resonant sheet 122 and the fourth resonant sheet 128 are arranged at intervals on the second inner surface 113, the second resonant sheet 124 and the third resonant sheet 126 are arranged at intervals on the first inner surface 112, the first resonant sheet 122 and the fourth resonant sheet 128 are disposed in different resonant cavities 117, and the second resonant sheet 124 and the third resonant sheet 126 are disposed in the same resonant cavity 117. The signal transmission path is the first resonant sheet 122, the second resonant sheet 124, the third resonant sheet 126 and the fourth resonant sheet 128 in sequence. Each time the signal passes through a metal resonant sheet 120, the phase of the signal will change by −90°. The inductive coupling occurs between the first resonant sheet 122 and the second resonant sheet 124, the inductive coupling occurs between the second resonant sheet 124 and the third resonant sheet 126, and the inductive coupling occurs between the third resonant sheet 126 and the fourth resonant sheet 128. The inductive coupling is used to enhance the high-end suppression of the resonant filter 100. The coupling amount between the first resonant sheet 122 and the third resonant sheet 126 is extremely small, and the coupling amount between the second resonant sheet 124 and the fourth resonant sheet 128 is extremely small, so there is no influence on the implementation of the resonant filter 100.

In one embodiment, the input port 130 and the output port 140 are connected to the first resonant sheet 122 and the fourth resonant sheet 128 respectively.

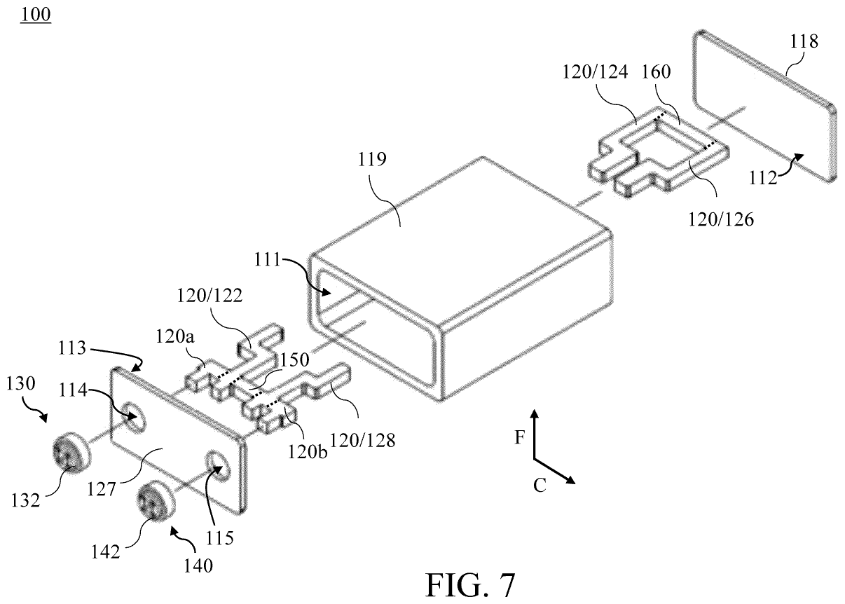

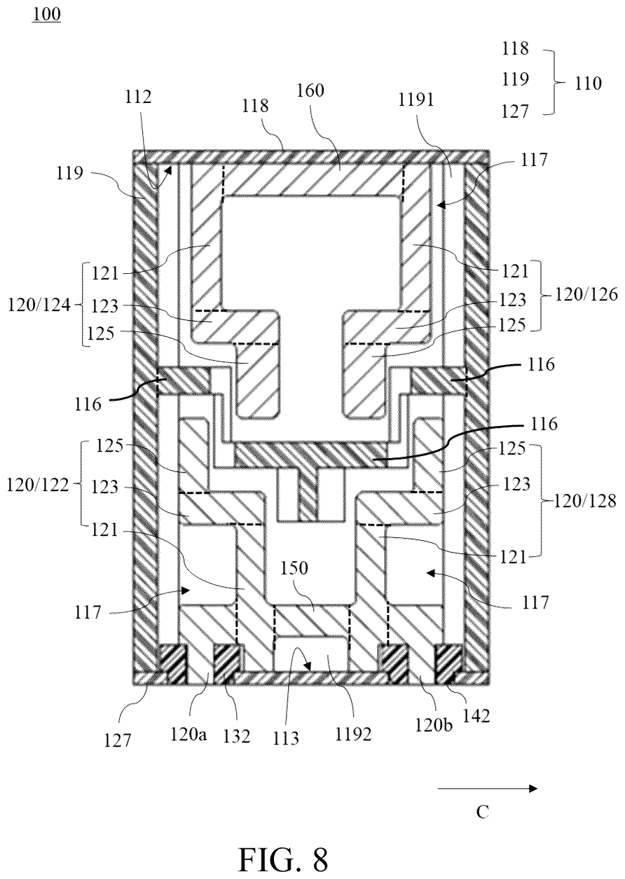

Please refer to FIG. 7 and FIG. 8, FIG. 7 is an exploded schematic diagram of another embodiment of the resonant filter of FIG. 1, and FIG. 8 is a cross-sectional schematic diagram of the resonant filter of FIG. 7. As shown in FIG. 7 and FIG. 8, it can be seen that the difference between the embodiments of FIG. 7 and FIG. 8 and the embodiments of FIG. 1 to FIG. 3 is that the first resonant sheet 122 and the fourth resonant sheet 128 are disposed in different resonant cavities 117 communicating with each other, and the capacitive cross coupling occurs between the first resonant sheet 122 and the fourth resonant sheet 128.

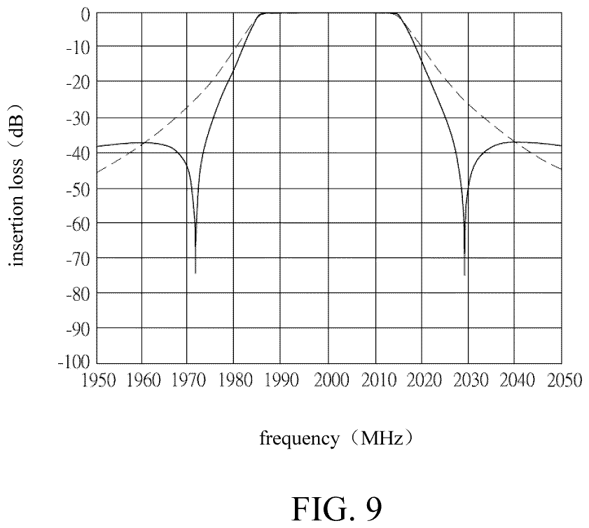

Please refer to FIG. 3, FIG. 8 and FIG. 9, and FIG. 9 is a diagram illustrating passband insertion loss curves of the resonant filter of FIG. 3 and the resonant filter of FIG. 8. In FIG. 9, the horizontal axis represents frequency in Megahertz (MHz), the vertical axis represents insertion loss in dB, the solid line is the passband insertion loss curve of the resonant filter 100 (i.e., the resonant filter 100 of FIG. 8) when the first resonant sheet 122 and the fourth resonant sheet 128 are disposed in different resonant cavities 117 communicating with each other, and the dotted line is the passband insertion loss curve of the resonant filter 100 (i.e., the resonant filter 100 of FIG. 3) when the first resonant sheet 122 and the fourth resonant sheet 128 are disposed in respective independent resonant cavities 117. As shown in FIG. 9, when the first resonant sheet 122 and the fourth resonant sheet 128 are disposed in respective independent resonant cavities 117, the first resonant sheet 122 and the fourth resonant sheet 128 are blocked by the partition rib 116, and no cross coupling occurs, so that the out-of-band signal suppression capability of the resonant filter 100 is relatively poor (i.e., slow signal attenuation). When the first resonant sheet 122 and the fourth resonant sheet 128 are disposed in different resonant cavities 117 communicating with each other, the capacitive cross coupling occurs between the first resonant sheet 122 and the fourth resonant sheet 128, so that the phase of the signal changes by +90°, and symmetrical zero points are realized on the left and right sides of the passband insertion loss curve of the resonant filter 100 (that is, a capacitive zero point is located on the left side of the passband to enhance the low-end suppression of the resonant filter 100, and an inductive zero point is located on the right side of the passband to enhance the high-end suppression of the resonant filter 100), thereby significantly improving the out-of-band signal suppression capability of the resonant filter 100.

In one embodiment, when the first resonant sheet 122 and the fourth resonant sheet 128 are disposed in different resonant cavities 117 communicating with each other, the resonant filter 100 may further comprise a first connecting rib 150, the first connecting rib 150 and the first resonant sheet 122 are substantially located in the same plane, and the first connecting rib 150 is connected to the first resonant sheet 122 and the fourth resonant sheet 128 (as shown in FIG. 8). The first connecting rib 150, the first resonant sheet 122 and the fourth resonant sheet 128 may be, but are not limited to, integrally formed, and the first connecting rib 150 is configured to increase the coupling amount of the capacitive cross coupling between the first resonant sheet 122 and the fourth resonant sheet 128.

In one embodiment, the resonant filter 100 may further comprise a second connecting rib 160, the second connecting rib 160 and the second resonant sheet 124 are substantially located in the same plane, and the second connecting rib 160 is connected to the second resonant sheet 124 and the third resonant sheet 126 (as shown in FIG. 8). The second connecting rib 160, the second resonant sheet 124 and the third resonant sheet 126 may be, but are not limited to, integrally formed, and the second connecting rib 160 is configured to enhance the electromagnetic coupling between the second resonant sheet 124 and the third resonant sheet 126.

In one embodiment, when other factors remain unchanged, the smaller the distance between the end of the second resonant sheet 124 away from the first inner surface 112 and the end of the third resonant sheet 126 away from the first inner surface 112 (that is, the smaller the distance between the coupling section 125 of the second resonant sheet 124 and the coupling section 125 of the third resonant sheet 126), the smaller the distance between the second connecting rib 160 and the first inner surface 112; the larger the distance between the end of the second resonant sheet 124 away from the first inner surface 112 and the end of the third resonant sheet 126 away from the first inner surface 112 (that is, the larger the distance between the coupling section 125 of the second resonant sheet 124 and the coupling section 125 of the third resonant sheet 126), the larger the distance between the second connecting rib 160 and the first inner surface 112. The larger the distance between the second connecting rib 160 and the first inner surface 112, the stronger the coupling effect between the second resonant sheet 124 and the third resonant sheet 126.

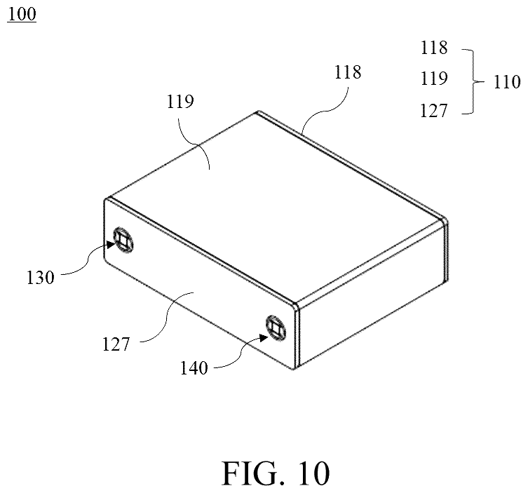

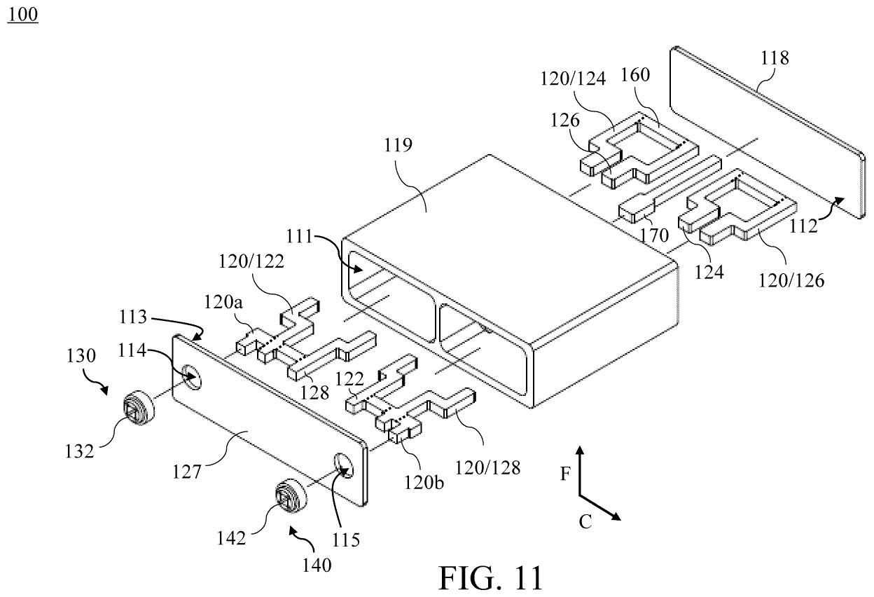

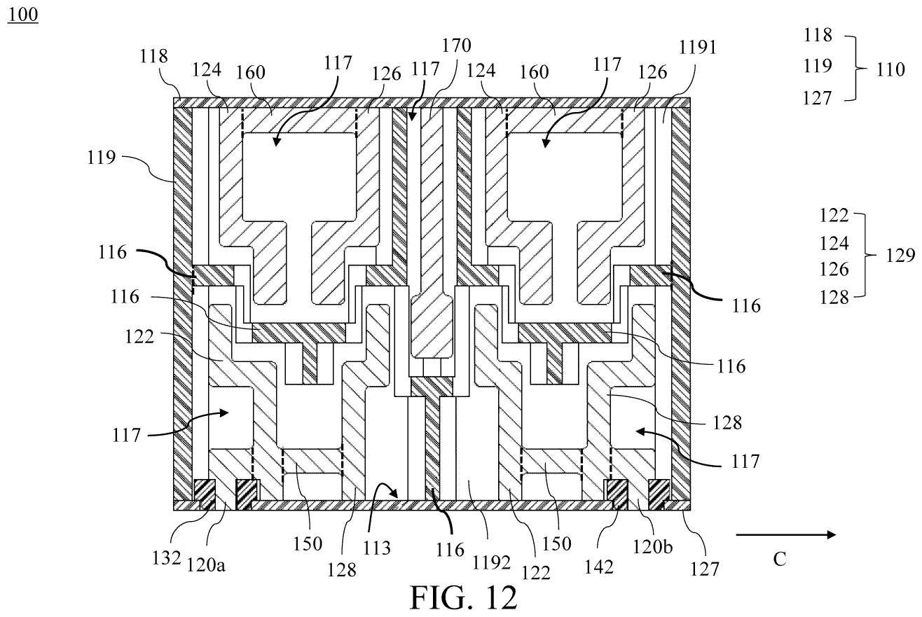

Please refer to FIG. 10 to FIG. 12, FIG. 10 is a three-dimensional diagram of a resonant filter according to still another embodiment of the present disclosure, FIG. 11 is an exploded schematic diagram of an embodiment of the resonant filter of FIG. 10, and FIG. 12 is a cross-sectional schematic diagram of the resonant filter of FIG. 11. As shown in FIG. 10 to FIG. 12, it can be seen that the first resonant sheet 122, the second resonant sheet 124, the third resonant sheet 126 and the fourth resonant sheet 128 may constitute a group of resonant sheets 129, and the plurality of metal resonant sheets 120 may comprise N groups of resonant sheets 129 and N−1 intermediate resonant sheets 170, an intermediate resonant sheet 170 is disposed between two adjacent groups of resonant sheets 129, N is an integer greater than or equal to 2, and each of the N−1 intermediate resonant sheets 170 is disposed on the first inner surface 112 or the second inner surface 113 and is coupled with the fourth resonant sheet 128 and the first resonant sheet 122 adjacent to two sides thereof (that is, an intermediate resonant sheet 170 is coupled with the fourth resonant sheet 128 of the former group of resonant sheets 129 and the first resonant sheet 122 of the latter group of resonant sheets 129, wherein the former group of resonant sheets 129 and the latter group of resonant sheets 129 are defined by the sequence of signal transmission) to form the signal connection. In this embodiment, N can be but not limited to 2, so the resonant filter 100 comprises two groups of resonant sheets 129 and an intermediate resonant sheet 170. The intermediate resonant sheet 170 may be disposed on the first inner surface 112, and the resonant filter 100 can generate two capacitive zero points and two inductive zero points due to the two groups of resonant sheets 129. It should be noted that the intermediate resonant sheet 170 is not coupled with the third resonant sheet 126 of the former group of resonant sheets 129 and the second resonant sheet 124 of the latter group of resonant sheets 129, so the intermediate resonant sheet 170 can be disposed on the first inner surface 112 or the second inner surface 113.

In one embodiment, the input port 130 and the output port 140 are connected to the first resonant sheet 122 of the first group of resonant sheets 129 and the fourth resonant sheet 128 of the Nth group of resonant sheets 129 respectively. For example, please refer to FIG. 12, the input port 130 and the output port 140 are connected to the first resonant sheet 122 of the first group of resonant sheets 129 (i.e., the leftmost group of resonant sheets 129 in FIG. 12) and the fourth resonant sheet 128 of the second group of resonant sheets 129 (i.e., the rightmost group of resonant sheets 129 in FIG. 12) respectively. Thus, the signal transmission path is the first resonant sheet 122, the second resonant sheet 124, the third resonant sheet 126 and the fourth resonant sheet 128 of the first group of resonant sheets 129, the intermediate resonant sheet 170, and the first resonant sheet 122, the second resonant sheet 124, the third resonant sheet 126 and the fourth resonant sheet 128 of the second group of resonant sheets 129 in sequence.

In one embodiment, the intermediate resonant sheet 170 disposed on the second inner surface 113 and the fourth resonant sheet 128 and the first resonant sheet 122 adjacent to two sides thereof are disposed in the same resonant cavity 117.

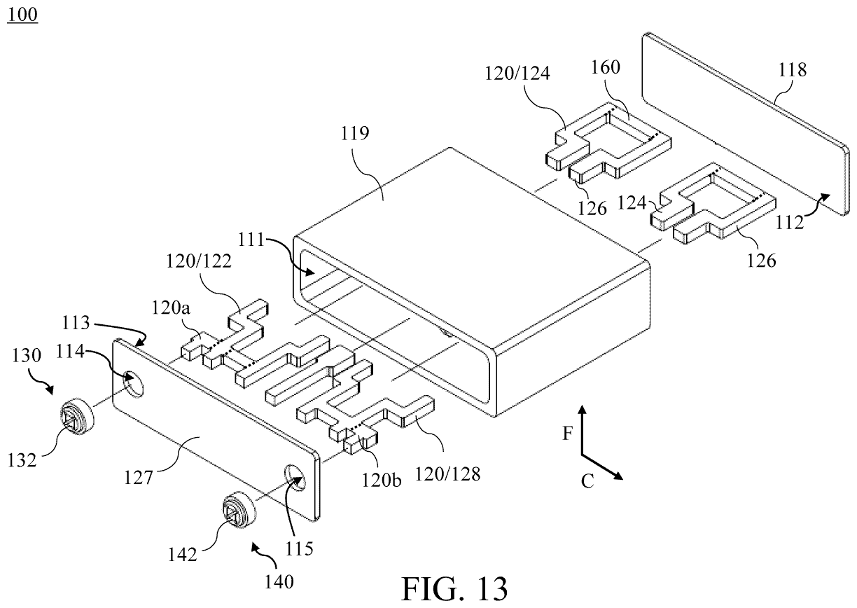

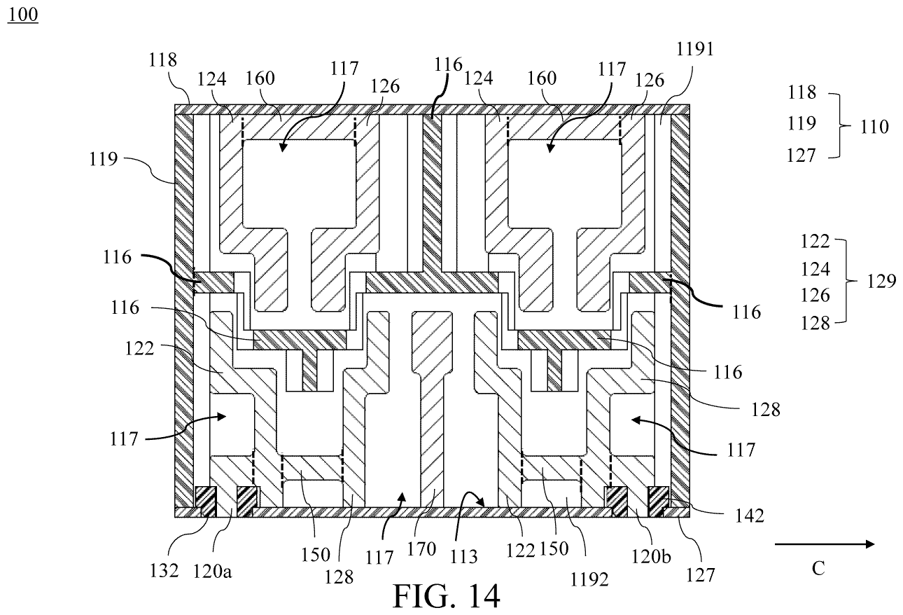

Please refer to FIG. 10, FIG. 13 and FIG. 14, FIG. 13 is an exploded schematic diagram of another embodiment of the resonant filter of FIG. 10, and FIG. 14 is a cross-sectional schematic diagram of the resonant filter of FIG. 13. As shown in FIG. 13 and FIG. 14, it can be seen that the difference between the embodiment of FIG. 13 and FIG. 14 and the embodiment of FIG. 11 and FIG. 12 is that the intermediate resonant sheet 170 of FIG. 13 and FIG. 14 is disposed on the first inner surface 112, and the intermediate resonant sheet 170 disposed on the first inner surface 112 and the second resonant sheet 124 and third resonant sheet 126 adjacent thereto (i.e., the third resonant sheet 126 of the former group of resonant sheets 129 and the second resonant sheet 124 of the latter group of resonant sheets 129) are disposed in different resonant cavities 117.

In summary, in the embodiments of the resonant filter of the present disclosure, the plurality of metal resonant sheets do not need to be bent and have the advantage of simple processing; the plurality of metal resonant sheets are substantially located in the same plane and are distributed oppositely, and the length of the resonant filter along the direction perpendicular to the arrangement direction of the plurality of metal resonant sheets is significantly reduced, which is conducive to the miniaturization development of the resonant filter; coupling occurs between two adjacent metal resonant sheets to form the signal connection, and the design of bending member is not required, so there is no problem of high processing difficulty and low dimensional accuracy. In addition, the resonant filter of the present disclosure can be a single-layer stacking, drawer-type design with a compact structure, and this architecture provides convenience for subsequent expansion of multiplexers. Besides, the resonant filter of the present disclosure is suitable for frequency bands above 5.5 GHz. Furthermore, the input port and the output port of the resonant filter of the present disclosure can be arranged in a more flexible manner to meet different design requirements.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A resonant filter, comprising:
a casing having an accommodating cavity, a first inner surface and a second inner surface opposite to the first inner surface, and provided with a first through hole and a second through hole communicating with the accommodating cavity;
a plurality of metal resonant sheets located in the accommodating cavity and disposed on the first inner surface and the second inner surface, wherein the plurality of metal resonant sheets are substantially located in a same plane and are distributed oppositely, and the plurality of metal resonant sheets are configured to generate coupling with one another to form a signal connection;
an input port engaged with the first through hole and connected to one of the plurality of metal resonant sheets; and
an output port engaged with the second through hole and connected to another of the plurality of metal resonant sheets.

2. The resonant filter according to claim 1, wherein the casing is further provided with a plurality of partition ribs, the plurality of partition ribs divide the accommodating cavity into a plurality of resonant cavities arranged in two rows, the plurality of metal resonant sheets are disposed in the plurality of resonant cavities, and two adjacent opposite resonant cavities communicate with each other.

3. The resonant filter according to claim 2, wherein the plurality of metal resonant sheets comprise a first resonant sheet, a second resonant sheet, a third resonant sheet and a fourth resonant sheet which are sequentially connected in signal connection, the first resonant sheet and the fourth resonant sheet are arranged at intervals on the second inner surface, the second resonant sheet and the third resonant sheet are arranged at intervals on the first inner surface, the first resonant sheet and the fourth resonant sheet are disposed in different resonant cavities, and the second resonant sheet and the third resonant sheet are disposed in the same resonant cavity.

4. The resonant filter according to claim 3, wherein the input port and the output port are connected to the first resonant sheet and the fourth resonant sheet respectively.

5. The resonant filter according to claim 3, wherein the different resonant cavities with the first resonant sheet and the fourth resonant sheet communicate with each other, and the first resonant sheet and the fourth resonant sheet are configured to generate capacitive cross-coupling with each other.

6. The resonant filter according to claim 5, further comprising a first connecting rib, wherein the first connecting rib and the first resonant sheet are substantially located in the same plane, and the first connecting rib is connected to the first resonant sheet and the fourth resonant sheet.

7. The resonant filter according to claim 3, further comprising a second connecting rib, wherein the second connecting rib and the second resonant sheet are substantially located in the same plane, and the second connecting rib is connected to the second resonant sheet and the third resonant sheet.

8. The resonant filter according to claim 7, wherein the smaller a distance between an end of the second resonant sheet away from the first inner surface and an end of the third resonant sheet away from the first inner surface, the smaller a distance between the second connecting rib and the first inner surface; the larger the distance between the end of the second resonant sheet away from the first inner surface and the end of the third resonant sheet away from the first inner surface, the larger the distance between the second connecting rib and the first inner surface.

9. The resonant filter according to claim 3, wherein the first resonant sheet, the second resonant sheet, the third resonant sheet and the fourth resonant sheet constitute a group of resonant sheets, the plurality of metal resonant sheets comprise N groups of resonant sheets and N−1 intermediate resonant sheets, an intermediate resonant sheet of the N−1 intermediate resonant sheets is disposed between two adjacent groups of resonant sheets of the N groups of resonant sheets, N is an integer greater than or equal to 2, and each intermediate resonant sheet of the N−1 intermediate resonant sheets is disposed on the first inner surface or the second inner surface and is configured to be coupled with the fourth resonant sheet and the first resonant sheet adjacent to two sides thereof to form a signal connection.

10. The resonant filter according to claim 9, wherein the input port and the output port are connected to the first resonant sheet of a first group of resonant sheets and the fourth resonant sheet of an Nth group of resonant sheets, respectively.

11. The resonant filter according to claim 9, wherein the intermediate resonant sheet disposed on the second inner surface and the fourth resonant sheet and the first resonant sheet adjacent to two sides thereof are disposed in the same resonant cavity.

12. The resonant filter according to claim 9, wherein the intermediate resonant sheet disposed on the first inner surface and the second resonant sheet and the third resonant sheet adjacent to two sides thereof are disposed in different resonant cavities.

13. The resonant filter according to claim 1, wherein the casing comprises a bottom plate, a housing and a cover plate, the housing is provided with a first opening and a second opening arranged opposite to each other, the bottom plate is disposed at the first opening, the cover plate is disposed at the second opening; the bottom plate, the housing and the cover plate are surrounded to form the accommodating cavity; the bottom plate has the first inner surface, and the cover plate has the second inner surface.

14. The resonant filter according to claim 13, wherein the first through hole and the second through hole are arranged on the bottom plate or the cover plate.

15. The resonant filter according to claim 14, wherein the input port comprises a first support seat, the one metal resonant sheet connected to the input port passes through the first support seat through a first tap plate and extends out of the casing, and the first tap plate and the one metal resonant sheet connected to the input port are integrally formed; the output port comprises a second support seat, the another metal resonant sheet connected to the output port passes through the second support seat through a second tap plate and extends out of the casing, and the second tap plate and the another metal resonant sheet connected to the output port are integrally formed.

16. The resonant filter according to claim 1, wherein the first through hole and the second through hole are arranged on the same side wall or different side walls of the casing.

17. The resonant filter according to claim 16, wherein the input port comprises a first port conductor and a first base, one end of the first port conductor is connected to the one metal resonant sheet, the first base is engaged with the first through hole, and another end of the first port conductor passes through the first base and extends out of the housing; the output port comprises a second port conductor and a second base, one end of the second port conductor is connected to the another metal resonant sheet, the second base is engaged with the second through hole, and another end of the second port conductor passes through the second base and extends out of the housing.

18. The resonant filter according to claim 1, wherein each of the plurality of metal resonant sheets comprises a upright section, an extension section extending from one end of the upright section, and a coupling section extending from one end of the extension section away from the upright section, an end of the upright section away from the extension section is connected on the first inner surface or the second inner surface, and the coupling section of each of the plurality of metal resonant sheets is close to the coupling section of an adjacent metal resonant sheet.

19. The resonant filter according to claim 1, wherein each of the plurality of metal resonant sheets is a sheet with a metal surface or a metal sheet.

20. The resonant filter according to claim 1, wherein the plurality of metal resonant sheets are not physically connected to each other.
